(19) United States
(12) Patent Application Publication
(10) Pub. No.: US 2025/0202944 A1
(43) Pub. Date: Jun. 19, 2025

(54) ZTNA TOKEN BASED FORWARDING PATH GENERATION MECHANISM

(71) Applicant: Fortinet, Inc., Sunnyvale, CA (US)

(72) Inventor: Kun Yu, Sunnyvale, CA (US)

(73) Assignee: Fortinet, Inc., Sunnyvale, CA (US)

(21) Appl. No.: 18/542,268

(22) Filed: Dec. 15, 2023

(51) Int. Cl. H04L 9/40

(52) U.S. Cl. CPC H04L 63/20; H04L 63/0236; H04L 63/108

(57) ABSTRACT

A system is disclosed. The system includes a network appliance to receive network traffic from a client, transmit an authentication request to an external server to determine access status of the client device to an end node associated with a service, receive an access token indicating that the client has access to the service and generate one or more forwarding path rules based on authorization tokens.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright @ 2023, Fortinet, Inc.

### FIELD

Embodiments discussed generally relate to securing network environments, and more particularly to systems and methods for determining zero trust network access policy from a perspective focused on one or more network elements.

### BACKGROUND

Zero-Trust network access (ZTNA) has become a popular model in cyber-security. ZTNA provides secure remote access to an organization's applications, data, and services based on clearly defined access control policies. As a result, ZTNA includes continuous authentication and least privilege access control. However, the ZTNA model leads to challenges for traditional access control systems. For example, ZTNA applications may lead to a rapid increase of policy numbers and dynamic access control granting and revocation based on authentication results.

### SUMMARY

Various embodiments provides to systems and methods for dynamically generating forwarding path rules at network appliances based on authentication tokens. This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A better understanding of the embodiments can be obtained from the following detailed description in conjunction with the following drawings, in which:

FIG. 1 illustrates one embodiment of a network architecture;

FIG. 2 illustrates another embodiment of a network architecture;

FIG. 3 illustrates yet another embodiment of a network;

FIG. 4 illustrates one embodiment of a network security appliance;

FIG. 5 is a flow diagram illustrating one embodiment of processing network traffic.

FIG. 6 is a flow diagram illustrating one embodiment of processing an access message.

FIG. 7 illustrates a process for generating dynamic forwarding paths; and

FIG. 8 illustrates an exemplary computer system in which or with which embodiments may be utilized.

### DETAILED DESCRIPTION

An example enterprise network may have hundreds of applications, and each of the hundreds of applications may comprise several interconnected tiers having workloads communicating between each other. Such workloads utilize common network infrastructure including, but not limited to, domain name system (DNS), dynamic host configuration protocol (DHCP), network time protocol (NTP), the internet, and/or management software (e.g., performance and/or health monitoring software. At the same time groups of clients (e.g., administrators, developers, testers, or the like) may desire access to the aforementioned workloads to perform their various tasks. In addition, network scanners and other administrative tools add complexity by connecting to each asset over a range of ports. In such an environment, determining a desired zero trust network access (ZTNA) is challenging, and as workloads and clients continue to become more dynamic, the complexity of determining desired security parameters and implementing those security parameters in one or more network appliances becomes progressively more complex. Currently, processes related to determining and setting firewall rules are performed manually, however, to the extent such rules are still being set and maintained manually, it is only time before complexity renders such an approach impossible.

As just one example, current ZTNA policies are statically configured on each access control device, including explicit source IP/destination IP information. However, it is difficult for administrators to revoke policies for every firewall along a network path and apply new policies as network resource IP addresses change from time to time (e.g., especially with wide spreading of macro-service infrastructures). This scenario worsens when ZTNA is applied since ZTNA requires grant access permission including least privilege access, which results in the explosion of the magnitude of policies. Continuous authentication is another challenge since it requires policies to be dynamically revoked whenever an authentication is invalid, or a user is not active during a defined time period.

According to embodiments, systems and methods for generating dynamic forwarding paths using authorization tokens is described. Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another, Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a “network security device” that may reside within the particular network that it is protecting or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs), NPs may be used to accelerate traffic by offloading network traffic from the main processor, CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

The term “network session” is used in its broadest sense as a temporary and interactive information interchange between two or more devices communicating over a network. A session is established at a certain point in time, and then ‘tom down’—brought to an end—at some later point.

Network routing is the process of selecting a path across one or more networks. The term “forwarding” is used in its broadest sense as a process of collecting data from one device and sending it to another device during packet routing. Forwarding performs some actions and simply forwards the packets which arrive in a network device. A “forwarding rule” or “forwarding path rule” specifies how to route network traffic to a destination. A forwarding rule includes an IP address, an IP protocol.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views or processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

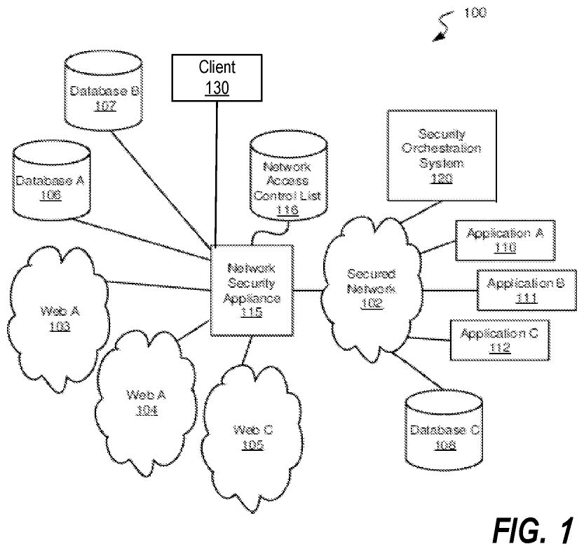

Turning to FIG. 1, network architecture 100 is shown in accordance with some embodiments. In the context of network architecture 100, a network security appliance 115 controls network traffic passing to/from a secured network 102. Secured network 102 may be any type of communication network known in the art. Those skilled in the art will appreciate that, secured network 102 can be a wireless network, a wired network or a combination thereof that can be implemented as one of the various types of networks, such as an Intranet, a Local Area Network (LAN), a Wide Area Network (WAN), an Internet, and the like. Further, network 102 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

The control applied by network security appliance 115 is in part based upon a network ACL 116 that includes a number of rules indicating which types of network traffic are allowed to pass to/from secured network 102, and which types of traffic are to be blocked from passing to/from secured network 102.

A security orchestration system 120 is used to monitor network traffic passing through network security appliance 115 to determine applications that are operating in relation to secured network 102 (e.g., application A 110, application B 111, and application C 112), and workloads corresponding to operation of the respective applications. Such workloads involve communications between one or more of the applications and one or more of a database A 106, a database B 107, a database C 108, a web A 103, a web B 104, and a web C 105. Web A 103, web B 104, and web C 105 represent external network destinations.

Using this workload information, security orchestration system 120 generates access control rules for each of the identified applications and generates an ACL for secured network 102. This generated ACL is deployed by installation in place of network ACL 116, In some embodiments, security orchestration system 120 is implemented on the same hardware as network security appliance 115 making it possible to more efficiently monitor network traffic passing to/from secured network 102.

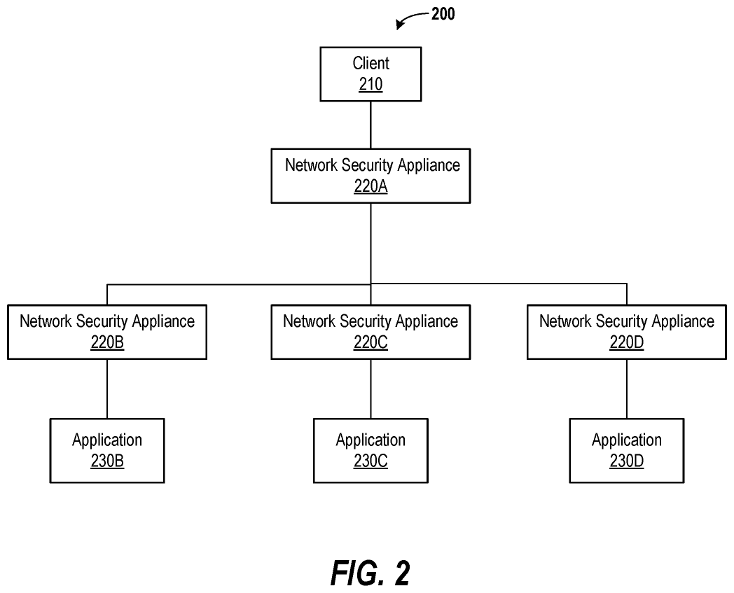

In one embodiment, network architecture 100 includes a client device (client) 130 that accesses applications 110-112 within secured network 102. In such an embodiment, a network traffic path between client 130 and the applications includes additional network security appliances 115 within secured network 102. For example, traffic between client 130 and a system executing application A 110 includes various network security appliances 115. FIG. 2 illustrates an exemplary network 200 including a client 210 coupled to application (or service) 230 endpoints (e.g., applications 230B, 230C and 230D) via network security appliances 220 (e.g., appliances 220A-222D). As shown in FIG. 2, network traffic including client 210 workloads accessing application 230B would travel along a path between client 210 and one or more end nodes on which application 230B reside via network security appliances 220A and 220B. Similarly client 210 traffic to application 230C would travel along a path including network security appliances 220A and 220C, and so on. As discussed above, ZTNA policies including forwarding path rules must be statically changed at each network security appliance 220 (e.g., by an administrator) in such a network for client 210.

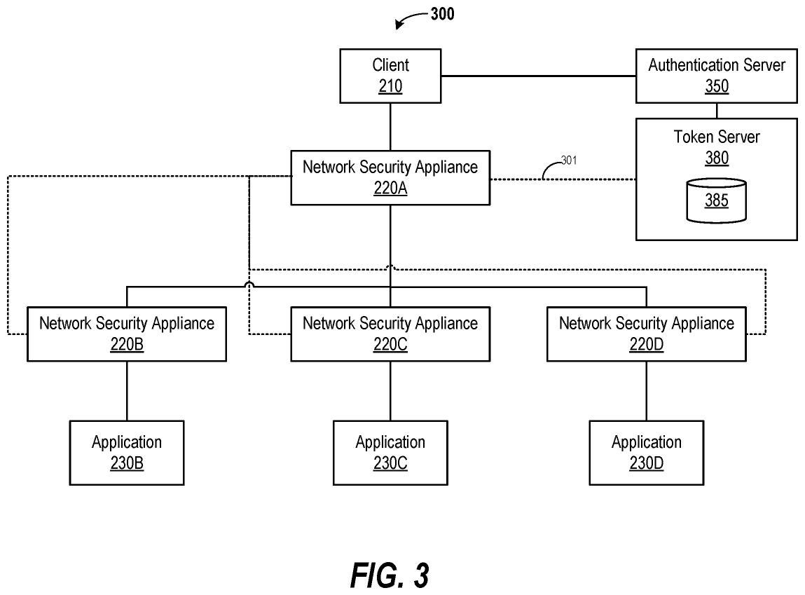

FIG. 3 illustrates one embodiment of network 300 implemented to facilitate dynamic generation of forwarding path rules. As shown in FIG. 3, network 300 includes an authentication server 350 and a token server 380, as well as the components shown in FIG. 2. According to one embodiment, authentication server 350 comprises a global resource registry of all destination resources that are to be accessed in network 300. In such an embodiment, registry includes information associated with each resource, such as protocol, port and owner information.

In a further embodiment, a user (e.g., at client 210) requests access to applications in secured network 102 (e.g., application 230) by launching a request workflow that is transmitted to administrator server 350 and reviewed there by an administrator. In this embodiment, access is granted upon administrator approval. Subsequently, the user information (e.g., authentication credentials and access status to one or more applications) is saved to an access database 385 at administrator server 350 at token server 380. Each time a user is authenticated for access to network 300, the source IP address of client 210 is updated at access database 385. In some embodiments, administrator server 350 may be implemented on the same hardware as token server 380.

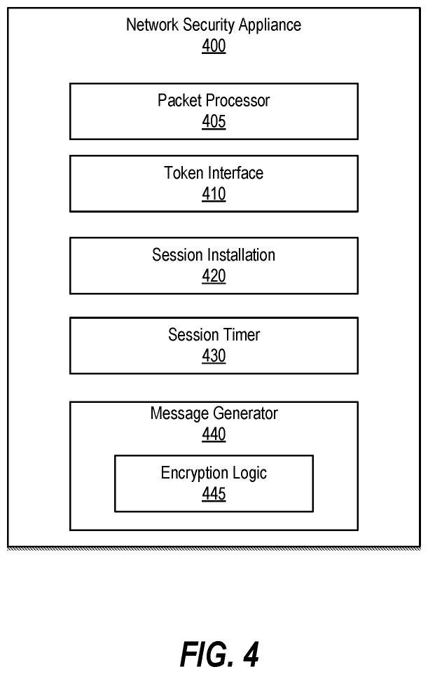

Upon being authenticated, client device may begin transmitting network traffic to access an application 230. A first network security appliance 220 (e.g., 220A) in the path to the application 230 receives the network traffic FIG. 4 illustrates one embodiment of a network security appliance 400 representative of network security appliance shown in FIG. 2. As shown in FIG. 4, network security appliance 400 includes a packet processor 405 that processes packets in the received client traffic. During processing packet processor 405 determines whether the source IP address is recognized as an IP address as permitted to route traffic through the network security appliance 220. The client device traffic is permitted upon a determination that the IP address has been recognized. Otherwise, a token interface 410 transmits an access grant request to token server 380 via a secure Out-of-band (OOB) interface 301 upon detecting that client 210 has an unrecognized source IP address.

In one embodiment, token server 380 receives the access grant request and performs a lookup of access database 385 to determine an access status to an end node associated with an application 230 based on a source IP address associated with the received request. Token server 380 generates an access grant (or access) token upon a determination that access is granted. In one embodiment, the access token comprises a token encrypted via a nonce-based symmetric encryption (e.g., from a 5-tuple and a random nonce). Subsequently, the access token is transmitted to the requesting network security appliance 220 via OOB interface 301. Token interface 410 receives the access token from token server 380.

Session installation logic 420 generates forwarding path rules upon token interface 410 receiving the access token. Session installation logic 420 also installs a network access policy and session to allow the client 210 traffic through the network security appliance 400. In one embodiment, installation logic 420 blocks the traffic upon a determination that no token has been received. In such an embodiment, token interface 410 receives a message from token server 380 indicating that the client is not to be granted access instead of receiving an access token.

According to one embodiment, traffic from client 210 will be allowed until a session time has expired. In such an embodiment, section timer 430 sets a timer upon session installation, enabling session installation logic 420 allows client 210 traffic until a time set by the timer has elapsed. Accordingly, session installation logic 420 revokes access by removing the policy/session once the timer has elapsed. In a further embodiment, access may be revoked upon receiving a revocation message from token server 380 any time after session installation.

Network security appliance 400 further includes a message generator 440 that generates an access message including the access token for transmission to the next network security appliance 400 in the path to the destination (e.g., application 230). In one embodiment, message generator 440 includes encryption logic 445 that encrypts the access token prior transmission.

Once received at the next network security appliance 400, the token interface at that appliance 400 processes the encrypted access token by decrypting and verifying the token. Once verified, another forwarding path is established by installing policy/session. Subsequently, an access message is generated in the manner discussed above. An encrypted token is then transmitted to the next network security appliance 400 hop in the path, where this process is again repeated. In one embodiment, each network security appliance 400 generates and transmits access messages based on its network configuration information. In such an embodiment, an access message is generated and transmitted upon a determination that another network security appliance 400 is coupled along the path to the traffic destination.

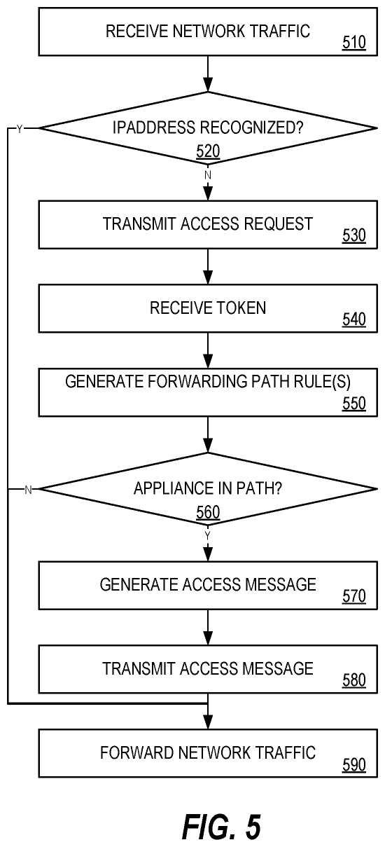

FIG. 5 is a flow diagram illustrating one embodiment of processing network traffic from a client at a network security appliance. At processing block 510, network traffic is received from a client device. At decision block 520, a determination is made as to whether the IP address of the client device has been recognized. If so, the network traffic from the client device is forwarded through the network security appliance, processing block 590. Otherwise, an access request is transmitted to the token server to determine whether the client is authorized for access, processing block 530. At processing block 540, the access token is received. However, a message from the token server indicating that the client is not authorized for access may be received, resulting in access being denied.

At processing block 550, one or more forwarding path rules are generated upon receiving the access token. Subsequently, the network policy/session is installed. At decision block 560, a determination is made as to whether another network security appliance is in the path to the destination. If not, control is forwarded to processing block 590 where network traffic from the client device is allowed. An access message including an encrypted access token is generated upon a determination that another network security appliance is in the path, processing block 570. At processing block 580, the access message is transmitted to the next security appliance before forwarding the network traffic through at processing block 590.

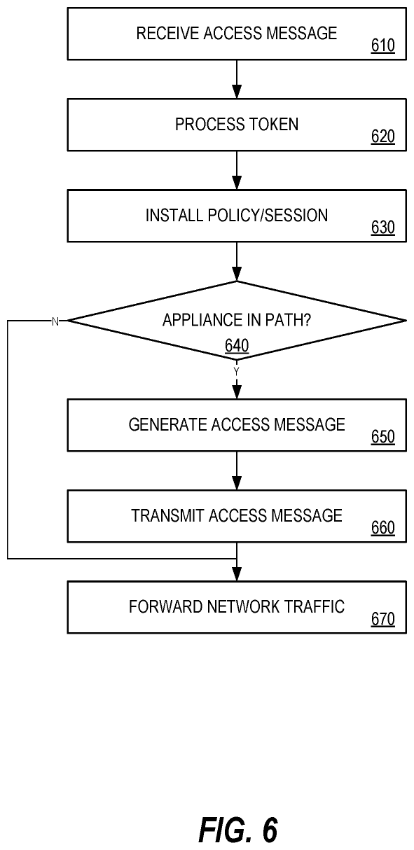

FIG. 6 is a flow diagram illustrating one embodiment of processing an access message received from a network security appliance. At processing block 610, an access message is received. At processing block 620, the access token included in the access message is processed (e.g., decryption and verification). At processing block 630, the network policy/session is installed once the token is verified. At decision block 640, a determination is made as to whether yet another network security appliance is in the path. If not, control is forwarded to processing block 670 where network traffic from the client device is allowed. Another access message including the encrypted access token is generated upon a determination that another network security appliance is in the path, processing block 650. At processing block 660, the access message is transmitted to the next security appliance before forwarded the network traffic through at processing block 670.

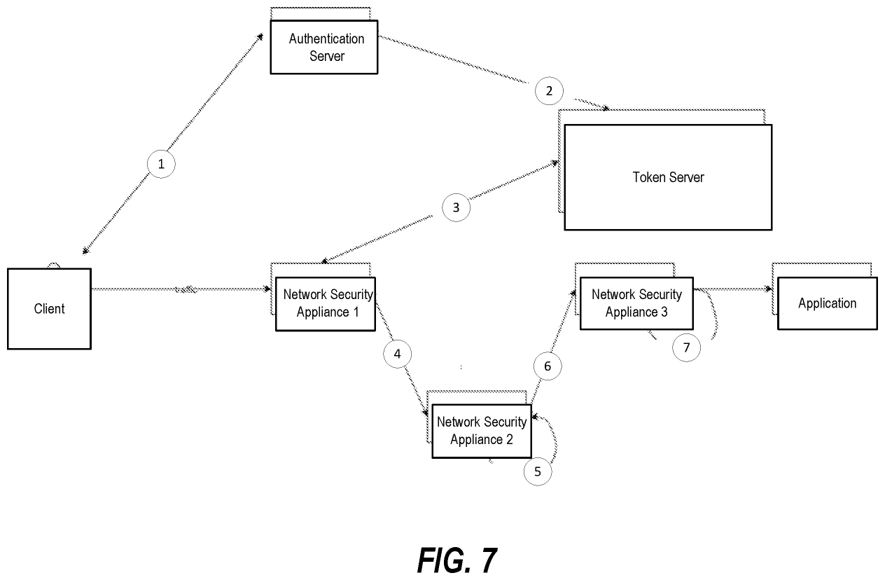

FIG. 7 illustrates a process for generating dynamic forwarding paths using authorization tokens. At process 1, a user at a client requests access to a registered application (or service) by launching a request workflow to an authentication server. Subsequently the request is approved by an administrator. At process 2, an access granted entry and source IP address associated with the client is updated and saved in an access database. Network security appliance 1, upon receiving client traffic, transmits an access request to the token server and receives an encrypted token at process 3. At process 4, the network security appliance 1 transmits an access message with an encrypted token to network security appliance 2. At process 5, the network security appliance 2 verifies the token and installs the sessions to allow traffic. At process 6, the network security appliance 2 transmits an access message with an encrypted token to network security appliance 3. At process 7, the network security appliance 3 verifies the token and installs the sessions to allow traffic to the application.

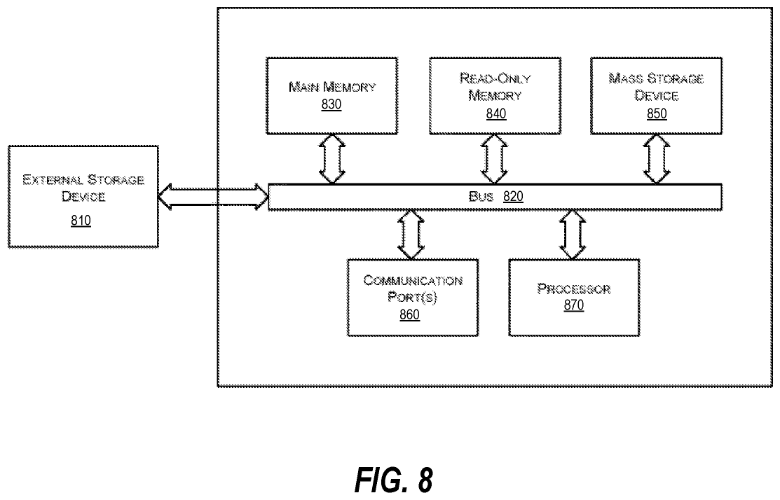

FIG. 8 illustrates an exemplary computer system 800 in which or with which embodiments may be utilized. Computer system 800 may represent a portion of a client device, network security appliance, and server. As shown in FIG. 8, computer system 800, includes an external storage device 810, a bus 820, a main memory 830, a read only memory 840, a mass storage device 850, a communication port 860, and a processor 870.

Those skilled in the art will appreciate that computer system 800 may include more than one processor 870 and communication ports 860. Examples of processor 870 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 870 may include various modules associated with embodiments of.

Communication port 860 can be any of an RS-232 port for use with a modem based dialup connection, a 10/100 Ethernet port, a Gigabit or 10 Gigabit port using copper or fiber, a serial port, a parallel port, or other existing or future ports. Communication port 860 may be chosen depending on a network, such a Local Area Network (LAN), Wide Area Network (WAN), or any network to which computer system connects.

Memory 830 can be Random Access Memory (RAM), or any other dynamic storage device commonly known in the art. Read only memory 840 can be any static storage device(s) e.g., but not limited to, a Programmable Read Only Memory (PROM) chips for storing static information e.g. start-up or BIOS instructions for processor 870.

Mass storage 850 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 820 communicatively couples processor(s) 870 with the other memory, storage and communication blocks. Bus 820 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 870 to software system.

Optionally, operator and administrative interfaces, e.g. a display, keyboard, and a cursor control device, may also be coupled to bus 820 to support direct operator interaction with computer system. Other operator and administrative interfaces can be provided through network connections connected through communication port 860. External storage device 810 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, it will be appreciated by those of ordinary skill in the art that the diagrams, schematics, illustrations, and the like represent conceptual views or processes illustrating systems and methods. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing described embodiments. Those of ordinary skill in the art further understand that the exemplary hardware, software, processes, methods, and/or operating systems described herein are for illustrative purposes and, thus, are not intended to be limited to any particular named.

It should be apparent to those skilled in the art that many more modifications besides those already described are possible without departing from the concepts herein. The subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments, other and further embodiments may be devised without departing from the basic scope thereof. The scope of the embodiments is determined by the claims that follow. The embodiments are not limited to the described embodiments, versions or examples, which are included to enable a person having ordinary skill in the art to make and use the embodiments when combined with information and knowledge available to the person having ordinary skill in the art.

What is claimed is:

1. A system comprising a network appliance to receive network traffic from a client device, transmit an authentication request to an external server to determine access status of the client device to an end node associated with a service, receive an access token indicating that the client device has access to the service and generate one or more forwarding path rules based on authorization tokens.

2. The system of claim 1, wherein the network appliance installs a network access policy and session based on the one or more forwarding path rules.

3. The system of claim 2, wherein the network appliance forwards the network traffic through the network appliance using the policy and session.

4. The system of claim 2, wherein the network appliance sets a timer upon installation of the policy and the session.

5. The system of claim 4, wherein the network appliance removes the policy and the session upon expiration of the timer.

6. The system of claim 2, wherein the network appliance determines whether a second network appliance is in a path to the service, generates an access message including the access token upon determining that the second network appliance is in the path and transmits the access message to a second network appliance.

7. The system of claim 6, wherein the second network appliance to receive the access message, verify a second forwarding path rule upon verification of the authorization token and install a second network access policy and session based on the second forwarding path rule to allow the client traffic through the second network appliance.

8. The system of claim 7, wherein the second network appliance generates a second access message including the access token and transmits the second access message to a third network appliance.

9. The system of claim 1, wherein the network appliance determines whether an IP address included in the network traffic associated with the client is recognized and transmits the authentication request to the external server upon determining that the IP address is not recognized.

10. The system of claim 9, wherein the network traffic is forwarded upon determining that the IP address is recognized.

11. A method comprising:
receiving network traffic from a client device;
transmitting an authentication request to an external server to determine access status of the client device to an end node associated with a service;
receiving an access token indicating that the client device has access to the service; and
generating one or more forwarding path rules based on authorization tokens.

12. The method of claim 11, further comprising installing a network access policy and session based on the one or more forwarding path rules.

13. The method of claim 12, further comprising forwarding the network traffic using the policy and session.

14. The method of claim 12, further comprising setting a timer upon installation of the policy and the session.

15. The method of claim 14, further comprising removing the policy and the session upon expiration of the timer.

16. At least one non-transitory computer readable medium having instructions stored thereon, which when executed by one or more processors, cause the processors to:
receive network traffic from a client device;
transmit an authentication request to an external server to determine access status of the client device to an end node associated with a service;
receive an access token indicating that the client device has access to the service; and
generate one or more forwarding path rules based on authorization tokens.

17. The computer readable medium of claim 16, which when executed by the one or more processors, further cause the processors to install a network access policy and session based on the one or more forwarding path rules.

18. The computer readable medium of claim 17, which when executed by the one or more processors, further cause the processors to forward the network traffic using the policy and session.

19. The computer readable medium of claim 17, which when executed by the one or more processors, further cause the processors to set a timer upon installation of the policy and the session.

20. The computer readable medium of claim 19, which when executed by the one or more processors, further cause the processors to remove the policy and the session upon expiration of the timer.
